(19) United States
(12) Patent Application Publication
(10) Pub. No.: US 2009/0127513 A1
(43) Pub. Date: May 21, 2009

(54) Uv curable electrically conductive film containing a polysilane

(76) Inventors: Laurie Nolta Kroupa, Midland, MI (US); Binh Thanh Nguyen, Midland, MI (US); Arthur James Tselepis, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 11/990,425

(22) PCT Filed: Aug. 15, 2006
(86) PCT No.: PCT/US06/31854

§ 371 Date: Feb. 13, 2008

Related U.S. Application Data
(60) Provisional application No. 60/710,690, filed on Aug. 23, 2005.

(51) Int. Cl. H01B 1/12

(52) U.S. Cl. 252/500

(57) ABSTRACT

Curable compositions contain (i) a polysilane, (ii) a cycloaliphatic epoxide, (iii) a cationic salt photoinitiator, (iv) an electrically conductive filler, and optionally (v) an adhesion promoter Electrically conductive films can be obtained by UV curing the curable compositions. These electrically conductive films have wide areas of application including use in the manufacture of electroluminescent lamps.

### FIELD OF THE INVENTION

This invention is directed to new UV curable electrically conductive films containing a polysilane, a cycloaliphatic epoxide, a cationic salt photoinitiator, an electrically conductive filler, and optionally an adhesion promoter.

### BACKGROUND OF THE INVENTION

Cycloaliphatic epoxy films are known to exhibit excellent chemical resistance and a high degree of hardness. However, the main draw back of these films is that they exhibit a low degree of flexibility. This limits their utility on flexible substrates such as plastics. Several methods of increasing the flexibility of epoxy films have been attempted but these methods typically require the incorporation of an incompatible second phase rubber material by high intensity mixing. It has been found herein that polysilanes are compatible with epoxy matrices and with the addition of a photoinitiator, they will cure upon exposure to UV irradiation to form flexible films with excellent adhesion to a wide variety of substrates. Electrically conductive filler materials are also compatible with the components used to make the films, and the electrically conductive films have wide areas of application including their use in the manufacture of electroluminescent lamps.

### BRIEF SUMMARY OF THE INVENTION

The invention is directed to a curable composition containing (i) a polysilane, (ii) a cycloaliphatic epoxide, (iii) a cationic salt photoinitiator, (iv) an electrically conductive filler, and optionally (v) an adhesion promoter. The invention is also directed to films obtained by UV curing the curable composition. These and other features of the invention will become apparent from a consideration of the detailed description.

### DETAILED DESCRIPTION OF THE INVENTION

According to the invention, UV curable electrically conductive compositions and cured films are prepared by combining a polysilane, a cycloaliphatic epoxide, a cationic salt photoinitiator, an electrically conductive filler, and optionally an adhesion promoter. These components are described below.

### The Polysilane (i)

Polysilanes for use in the invention are disclosed in U.S. Pat. No. 4,260,780 (Apr. 7, 1981); U.S. Pat. No. 4,276,424 (Jun. 30, 1981); U.S. Pat. No. 4,314,956 (Feb. 9, 1982); and U.S. Pat. No. 4,324,901 (Apr. 13, 1982). They include linear and branched peralkylpolysilanes such as Me(Me₂Si)_{X}Me; cyclic peralkylpolysilanes such as (Me₂Si)_{X} where Me represents methyl. Polysilacycloalkanes can also be used having the formula (RR′Si)_{X} wherein R and R′ are not the same and can be an alkyl group, an aryl group, or an aralkyl group, and x is an integer of 4-7. Some examples of suitable alkyl groups are groups containing 1-10 carbon atoms that can also be substituted with halogen, such as methyl, ethyl, propyl, isopropyl, cyclohexyl, 3,3,3-trifluoropropyl, and tertiary butyl groups. Some examples of suitable aryl and aralkyl groups include phenyl, naphthyl, and benzyl.

Hydrogen functional branched polysilanes can be used having Formula I:

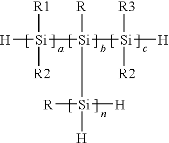

In this formula, R, R1, R2, and R3 are alkyl groups, aryl groups, cycloalkyl groups, aralkyl groups, or alkaryl groups; and the values of a, b, c, and n, are such as to provide hydrogen functional branched polysilanes having a number average molecular weight Mₙ in the range of 10,000-50,000.

The hydrogen functional branched polysilanes shown in Formula I can be capped to provide capped branched polysilanes, and capped branched polysilanes can also be used herein having Formula II:

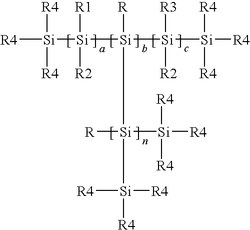

In this formula, R, R1, R2, and R3 are alkyl groups, aryl groups, cycloalkyl groups, aralkyl groups, or alkaryl groups; R4 is an alkyl group, an aryl group, a cycloalkyl group, an aralkyl group, an alkaryl group, or an alkoxy group; and the values of a, b, c, and n, are such as to provide capped branched polysilanes having a number average molecular weight Mₙ in the range of 10,000-50,000.

These hydrogen functional branched polysilanes, capped branched polysilanes, and methods of preparing them, are described in detail in the common assignee's copending U.S. Provisional application Ser. No. 60/571,184, filed on May 14, 2004, and entitled Method of Making Branched Polysilanes. Generally, the branched polysilanes are prepared by a Wurtz-type coupling reaction by reacting a mixture of a dihalosilane and a trihalosilane with an alkali metal coupling agent in an organic liquid medium. The reaction mixture is free of tetrahalosilanes, and branched polysilanes are recovered from the reaction mixture. The capped branched polysilanes are prepared by a Wurtz-type coupling reaction by reacting a mixture of a dihalosilane and a trihalosilane with an alkali metal coupling agent in an organic liquid medium. The reaction mixture is free of tetrahalosilanes. A capping agent is added to the reaction mixture, and capped branched polysilanes are recovered from the reaction mixture. The capping agent can be a monohalosilane, monoalkoxysilane, dialkoxysilane, or trialkoxysilane.

Branched polysilane copolymers can be used herein and are described in detail in the common assignee's copending U.S. Provisional application Ser. No. 60/675,635, filed on Apr. 28, 2005, and entitled Method of Making Branched Polysilanes Copolymers. These compositions are prepared by a Wurtz-type coupling reaction in which there is reacted a mixture of a first dihalosilane, a second dihalosilane, and a single trihalosilane, with an alkali metal coupling agent in an organic liquid medium, and then recovering the branched polysilane copolymers from the reaction mixture. The first dihalosilane, the second dihalosilane, and the trihalosilane have respectively the formulas:

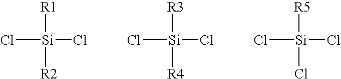

wherein R1, R2, R3, R4, and R5 represent an alkyl group, a cycloalkyl group, an aryl group, an aralkyl group, an alkaryl group, or an alkenyl group; provided that the R1 and R2 in the first dihalosilane are not the same as the R3 and R4 in the second dihalosilane.

### The Cycloaliphatic Epoxide (ii)

Cycloaliphatic epoxides useful in compositions of the invention can be monomeric epoxy compounds or polymeric epoxy compounds. These compositions generally have on average at least one polymerizable epoxy group per molecule, but preferably two or more epoxy groups per molecule. Some examples of useful cycloaliphatic epoxides are those which contain cyclohexene oxide groups such as epoxycyclohexanecarboxylates typified by 3,4-epoxycyclohexylmethyl-3,4-epoxycyclohexane carboxylate, and bis(3,4-epoxy-6-methylcyclohexylmethyl) adipate. Such cycloaliphatic expoxides may vary from low molecular weight monomeric materials to high molecular weight polymers, and may vary greatly in the nature of their backbone and/or substituent groups. Mixtures of cycloaliphatic epoxides can also be used in compositions of the invention.

The Dow Chemical Company, Midland, Mich., is a major source of cycloaliphatic expoxides in the United States for cycloaliphatic epoxides useful for the invention. These cycloaliphatic epoxide resins are available from Dow under their trademark Cyracure™. Some representative resinous Dow products include Cyracure™ UVR-6105, Cyracure™ UVR-6107, Cyracure™ UVR-6110, and Cyracure™ UVR-6128, for example. These resinous compositions can have a viscosity at 25° C. that ranges from 220-250 mm²/s, 250-350 mm²/s, 350-450 mm²/s, and 550-750 mm²/s, for example. Generally, Dow's cycloaliphatic epoxides such as Cyracure™ UVR-6105, Cyracure™ UVR-6107, and Cyracure™ UVR-6110, have a structure generally corresponding to the formula:

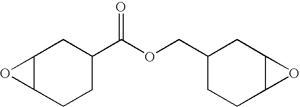

The chain linking the two epoxy moieties may be extended for applications where a higher viscosity or a more flexible film is required. Dow's cycloaliphatic epoxides such as Cyracure™ UVR-6128 have a structure generally corresponding to the formula:

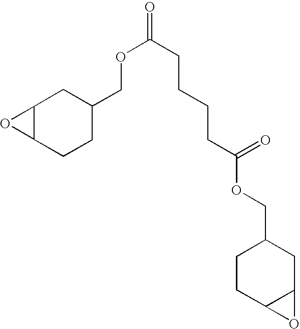

Reference may also be had to Dow's Publication entitled Tougher Cycloaliphatic Epoxides by Wells Carter and Mark Jupina, wherein the chemical structure of sixteen other resins are shown, such as resins identified as E278, E292, E306, Ei306, E334, E359, E363, E377, Ei377, E391, E408, E362, E756, E1000, EEC, and BEC.

It may be desirable in some instances to include a monomeric epoxide to control the viscosity and surface tension of the filled composition. Some suitable examples include compounds such as 4-vinyl-1-cyclohexene 1,2-epoxide; limonene oxide; and cyclohexene oxide; shown respectively below.

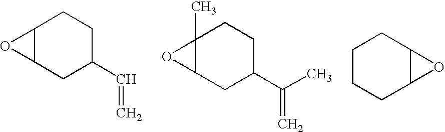

The Cationic Salt Photoinitiator (iii)

The photoinitiators useful in the compositions of the invention are cationic salts. They can be an iodonium, a sulfonium, or other onium type cationic salt photoinitiator. The cationic salt photoinitiator can be used alone or it can be combined with a photosensitizer. Some examples of compounds which act as a photosensitizer for the photoinitiator include thioxanthone and its derivatives, benzophenone and its derivatives, hydroxyalkylphenones, anthracene and its derivatives, perylene, xanthone, pyrene, and anthraquinone. Preferred for use herein are thioxanthones such as isopropylthioxanthone shown below. When included in the composition, a ratio of about 9 parts by weight of the cationic salt photoinitiator and one part by weight of the photosensitizer are employed.

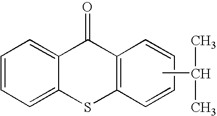

Preferred for use herein are cationic iodonium salt photoinitiators. These photoinitiators initiate the reaction of the epoxy functionality on the cycloaliphatic epoxide at the surface of the composition when light is applied. The cationic photoinitiator upon irradiation with ultraviolet light generates a super acid, i.e., a Lewis acid, which catalyzes the cationic cure process. The acid generated in the photolysis step reacts with the epoxy functional material adding a proton to the epoxy group. After rearrangement, this positively charged species then further reacts with an additional mole of epoxy, leading to further propagation of the growing polymer chain. In the presence of compounds containing hydroxyl groups, a chain transfer reaction takes place.

Some examples of cationic iodonium salt photoinitiators that can be used include diphenyliodononium tetrafluoroborate, diphenyliodononium hexafluorophosphate, di-p-tolyl-iodononium fluoroborate,

4-methoxydiphenyliodononium fluoroborate, diphenyliodononium hexafluoroarsenate, bis(4-n-heptylphenyl) iodononium hexafluoroarsenate, bis(4-n-tridecylphenyl) iodononium hexafluoroantimonate, bis(4-n-dodecylphenyl) iodononium hexafluoroantimonate, and bis(nonadecylphenyl) iodononium hexafluoroantimonate. Reference may be had to U.S. Pat. No. 4,310,469 (Jan. 12, 1982) for these and other suitable compositions.

Other commercially available cationic iodonium salt photoinitiators that can be used include Sarcat CD-1012, a composition available from the Sartomer Company, Inc., Exton, Pa., Rhodorsil R-2074 a composition available from Rhodia Incorporated, Cranbery, N.J., (4-octyloxyphenyl) phenyl iodonium hexafluoroantimonate, (4-octyloxyphenyl) phenyl iodonium hexafluorophosphate, (4-decyloxyphenyl) phenyl iodonium hexafluoroantimonate, and (4-decyloxyphenyl) phenyl iodonium hexafluorophosphate.

The cationic iodonium salt photoinitiator, and the photosensitizer when it is included, are both solid materials, and therefore it may be desirable to pre-dissolve these materials in a suitable solvent prior to incorporation into the composition. Some examples of solvents include alcohols such as decyl alcohol; liquid phenols such as nonyl phenol; and liquid lactones such as propylene carbonate and gamma butyrolactone. In this instance, the catalyst combination contains 30-50 parts by weight of the cationic iodonium salt photoinitiator per 100 parts by weight of the solvent.

### The Electrically Conductive Filler (iv)

The electrically conductive filler used herein can be particles having at least an outer surface of a metal such as silver, gold, copper, nickel, platinum, palladium, and alloys thereof. Fillers of silver, gold, copper, nickel, platinum, palladium, and alloys thereof, typically have the form of a powder or flakes with an average particle size of from 0.5-20 μm. In the case of electrically conductive fillers of metal particles having the form of flakes, the surface of the particles may be coated with a lubricant such as a fatty acid or fatty acid ester. Such lubricants are typically introduced during the milling of metal powders to form flakes to prevent the powder from cold welding or forming large aggregates. Even when the flakes are washed with a solvent after milling, some lubricant may remain chemisorbed on the surface of the metal.

The electrically conductive filler can also be a filler prepared by treating the surfaces of the particles with at least one organosilicon compound. Suitable organosilicon compounds include organochlorosilanes, organosiloxane, organodisilazanes, and organoalkoxysilanes. The filler can be a single electrically conductive filler as described above or a mixture of two or more such fillers that differ in composition, surface area, surface treatment, particle size, or particle shape. Preferably, the electrically conductive filler of the present invention comprises particles consisting of silver, and more preferably particles consisting of silver having the form of flakes. The concentration of the filler is sufficient to impart electrical conductivity to the composition. Typically, the concentration of the filler is such that the cured composition has a contact resistance less than about 2Ω and a volume resistivity less than about 0.001 Ω·cm.

Some examples of suitable commercially available materials are metal powder and flake products manufactured by the Ferro Corporation, Cleveland Ohio. Representative products include Copper Flake 300 having fine flakes and a fine particle size distribution, Copper Flake 550 having fine flakes of 10-18 microns, Copper Flake 800 having coarse flakes, Copper Powder 200 spherical copper powder, Gold Powder 2000 having spherical particles, Gold Flake 0502 having a mid-range particle size, Silver Flake 10A having large flakes, Silver Flake 26 having thick flakes, Silver Flake 29 having very fine flakes, Silver Flake 52 having a low surface area flakes and a high density, and Silver Flake 120 having ultra-fine flakes.

### The Adhesion Promoter (v)

The adhesion promoter is an optional component. Some example of adhesion promoters suitable for use herein are described in U.S. Pat. No. 4,082,726 (Apr. 4, 1978), U.S. Pat. No. 4,087,585 (May 2, 1978), U.S. Pat. No. 4,732,932 (Mar. 22, 1988), U.S. Pat. No. 5,789,084 (Aug. 4, 1998), and U.S. Pat. No. 6,124,407 (Sep. 26, 2000). Such adhesion promoters are organosilicon compounds including silanes and siloxanes that contain one or more epoxy groups such as 5,6-epoxyhexyltriethoxysilane, 3-glycidoxypropyltriethoxysilane, 3-glycidoxypropyltrimethoxysilane, 3-glycidoxypropyldimethylethoxysilane, 3-glycidoxypropyldimethylmethoxysilane, 3-glycidoxypropylmethyldiethoxysilane, 3-glycidoxypropylmethyldimethoxysilane, 2-(3,4-epoxycyclohexyl)ethyltrimethoxysilane, and 2-(3,4-epoxycyclohexyl)ethyltriethoxysilane. These compositions can be used herein in amounts of 0.1-5.0 percent by weight, preferably 0.1-1.0 percent by weight of the adhesion promoter, based on the weight of the composition.

### Miscellaneous Components (vi)

Other miscellaneous components can be used in conjunction with the principal components of the curable composition including stabilizers, plasticizers, pigments, waxes, slip aids, leveling aids, and surfactants.

### Amounts of the Components

The compositions herein can be prepared using the following amounts of the components based on the total weight of the curable composition.

(i) 1-10 percent by weight of the polysilane,
(ii) 10-40 percent by weight of the cycloaliphatic epoxide,
(iii) 0.1-5 percent by weight of the cationic salt photoinitiator,
(iv) 50-80 percent by weight of the electrically conductive filler, and
(v) 0-5 percent by weight of the adhesion promoter, preferably 0.1-1 percent by weight when present in the composition.

### EXAMPLES

The following examples are set forth in order to illustrate the invention in more detail.

### Example 1

### Curable Composition

In this example, a first part A was prepared by combining a cycloaliphatic epoxide and a polysilane. A second part B was prepared by combining an additional amount of the cycloaliphatic epoxide used in A, a cationic iodonium salt photoinitiator, and an adhesion promoter. A composition to be cured was then prepared by combining A and B with an electrically conductive filler and a wetting agent for the filler. Part A contained 90 percent by weight of the cycloaliphatic epoxide and 10 percent by weight of the polysilane. Part B contained 94 percent by weight of the cycloaliphatic epoxide used in A, 5 percent by weight of the cationic iodonium salt photoinitiator, and one percent by weight of the adhesion promoter. The composition contained 14 percent by weight of A, 14 percent by weight of B, 2 percent by weight of the wetting agent, and 70 percent by weight of the electrically conductive filler.

(i) The polysilane was a solid compound corresponding to Formula I above in which R and R1 were methyl, and in which R2 and R3 were phenyl. Similar results obtained in this and the following examples were also obtained in which the polysilane was a compound corresponding to Formula II above, in which R was methyl, R1 was methyl, R2 was phenyl, and R3 was methyl. The three R4 groups used to cap the four silicon atoms in Formula II consisted of two methyl groups and one phenyl group, respectively.

(ii) The cycloaliphatic epoxide was a resinous liquid composition sold under the trademark Cyracure™ UVR-6105 by The Dow Chemical Company, Midland, Mich.

(iii) The cationic iodonium salt photoinitiator was a solution containing 50 percent by weight of 1-decanol as solvent, 45 percent by weight of a methylphenyl phenyl iodonium hexafluoroantimonate compound as the photoinitiator, and 5 percent by weight of isopropylthioxanthone as the photosensitizer.

(iv) The electrically conductive filler was Silver Flake 52 manufactured by the Ferro Corporation, Cleveland Ohio. A wetting agent was included for the filler that was a low volatility aliphatic hydrocarbon sold under the trademark Isopar™ by the Exxon Mobil Corporation, Houston, Tex.

(v) The adhesion promoter was 2-(3,4-epoxycyclohexyl)ethyltrimethoxysilane.

### Example 2

### UV Curing

The curable composition prepared in Example 1 was applied as a 2 mil thick film on a flexible polyvinylchloride plastic substrate, and UV cured using a Mercury Vapor Lamp at about 2-joule/cm² intensity. The resulting film was flexible, and when exposed to light and air for one month, it remained stable. This electrically conductive film had a volume resistivity of 1.86×10⁻⁴ ohm-cm.

### Example 3

### Comparison

Example 2 was repeated with a curable composition that did not contain the polysilane. The resulting film was very fragile compared to the film in Example 2 containing the polysilane.

### Example 4

### Adhesion Test

In this test, the adhesive characteristic of a Conductive Ink to a Solder Masked FR4 Board is estimated. The film is cut through to the substrate with a series of lines to form a grid. A piece of tape is applied and then pulled off rapidly. The grid is examined and the amount of the film remaining on the surface is reported as percent adhesion or a numerical rating ranging from a low rating of 0 B to a high rating of 5 B. The cutter used is a single edge razor blade, and the tape is a transparent Scotch) Brand No. 600. Reference may be had to ASTM D3359-97 Standard Test Method for Measuring Adhesion by Tape Test for the details of the procedure.

The adhesion ratings are 0 B indicating flaking and detachment; 1 B indicating that the coating has flaked along the edges of cuts in large ribbons, whole squares have detached, and the area affected is 35-65 percent; 2 B indicating that the coating is flaked along the edges and on parts of the squares, and the area affected is 15-35 percent; 3 B indicating that small flakes of the coating are detached along edges and at intersections of cuts, and the area affected is 5-15 percent; 4 B indicating that small flakes of the coating are detached at intersections, and less than 5 percent of the area is affected; and 5 B indicating that the edges of the cuts are completely smooth, and none of the squares are detached. The film prepared in Example 2 was tested according to this test protocol and determined to have a rating of 5 B.

### Example 5

### Solvent Resistance Test

In this test, the solvent resistance of a cured film is evaluated by determining the number of rub cycles required to remove the film from a substrate. The strokes are applied using a piece of cheesecloth saturated with acetone under a constant weight load.

According to the procedure, the weighted cloth is moved back and forth a distance of 1-2 cm in a straight line without any additional pressure other than its own weight. The number of cycles is determined by count one forward and backward stroke as a single cycle. The rubbing speed is 80-120 cycles/minute. Counting is continued until the first sign of bare substrate is visible. The number of cycles is used as a measure of Solvent Resistance. If the number of cycles exceeds 100, the test is stopped and the results are reported as greater than 100. Reference may be had to ASTMD1308 Standard Test Method for Effect of Chemicals on Clear and Pigmented Organic Finishes for the details of the procedure. The film prepared in Example 2 was tested according to this test protocol and determined to have a rating of greater than 100 cycles.

Other variations may be made in compounds, compositions, and methods described herein without departing from the essential features of the invention. The embodiments of the invention specifically illustrated herein are exemplary only and not intended as limitations on their scope except as defined in the appended claims.

We claim:

1. A curable composition comprising:
(i) a polysilane selected from the group consisting of linear peralkylpolysilanes, branched peralkylpolysilanes, cyclic peralkylpolysilanes, polysilacycloalkanes, hydrogen functional branched polysilanes, capped branched polysilanes, and branched polysilane copolymers;
(ii) a cycloaliphatic epoxide;
(iii) a cationic salt photoinitiator;
(iv) an electrically conductive filler; and optionally
(v) an adhesion promoter.

2. A curable composition according to claim 1 comprising:
(i) 1-10 percent by weight of the polysilane;
(ii) 10-40 percent by weight of the cycloaliphatic epoxide;
(iii) 0.1-5 percent by weight of the cationic salt photoinitiator;
(iv) 50-80 percent by weight of the electrically conductive filler; and
(v) 0-5 percent by weight of the adhesion promoter; based on the total weight of the composition.

3. A curable composition according to claim 1 in which the polysilane is a hydrogen functional branched polysilane having the formula: 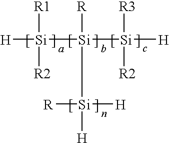
wherein R, R1, R2, and R3 are alkyl groups, aryl groups, cycloalkyl groups, aralkyl groups, or alkaryl groups; and the values of a, b, c, and n are such as to provide hydrogen functional branched polysilanes having a molecular weight in the range of 10,000-50,000.

4. A curable composition according to claim 1 in which the polysilane is a capped branched polysilane having the formula: 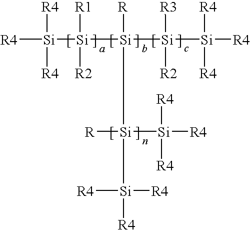
wherein R, R1, R2, and R3 are alkyl groups, aryl groups, cycloalkyl groups, aralkyl groups, or alkaryl groups; R4 is an alkyl group, an aryl group, a cycloalkyl group, an aralkyl group, an alkaryl group, or an alkoxy group; and the values of a, b, c, and n, are such as to provide capped branched polysilanes having a molecular weight in the range of 10,000-50,000.

5. A curable composition according to claim 1 in which the cycloaliphatic epoxide has the formula: 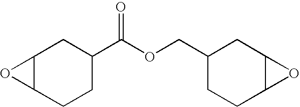
or the formula:

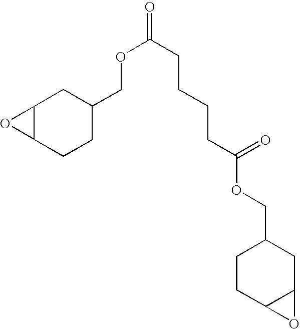

6. A curable composition according to claim 1 in which the cationic salt photoinitiator is a cationic iodonium salt photoinitiator selected from the group consisting of diphenyliodononium tetrafluoroborate, diphenyliodononium hexafluorophosphate, di-p-tolyl-iodononium fluoroborate, 4-methoxydiphenyliodononium fluoroborate, diphenyliodononium hexafluoroarsenate, bis(4-n-heptylphenyl) iodononium hexafluoroarsenate, methylphenyl phenyl iodonium hexafluoroantimonate, bis(4-n-tridecylphenyl) iodononium hexafluoroantimonate, bis(4-n-dodecylphenyl) iodononium hexafluoroantimonate, bis(nonadecylphenyl) iodononium hexafluoroantimonate, (4-octyloxyphenyl) phenyl iodonium hexafluoroantimonate, (4-octyloxyphenyl) phenyl iodonium hexafluorophosphate, (4-decyloxyphenyl)phenyl iodonium hexafluoroantimonate, and (4-decyloxyphenyl) phenyl iodonium hexafluorophosphate.

7. A curable composition according to claim 1 in which the cationic salt photoinitiator includes a photosensitizer selected from the group consisting of thioxanthone, thioxanthone derivatives, benzophenone, benzophenone derivatives, hydroxyalkylphenones, anthracene, anthracene derivatives, perylene, xanthone, pyrene, and anthraquinone.

8. A curable composition according to claim 1 in which the electrically conductive filler comprises particles having at least an outer surface of a metal selected from the group consisting of silver, gold, copper, nickel, platinum, palladium, and alloys thereof, and having an average particle size of 0.5-20 μm.

9. A curable composition according to claim 1 in which the composition includes an adhesion promoter selected from the group consisting of 5,6-epoxyhexyltriethoxysilane, 3-glycidoxypropyltriethoxysilane, 3-glycidoxypropyltrimethoxysilane, 3-glycidoxypropyldimethylethoxysilane, 3-glycidoxypropyldimethylmethoxysilane, 3-glycidoxypropylmethyldiethoxysilane, 3-glycidoxypropylmethyldimethoxysilane, 2-(3,4-epoxycyclohexyl)ethyltrimethoxysilane, and 2-(3,4-epoxycyclohexyl)ethyltriethoxysilane.

10. A film comprising the UV cured composition according to claim 1.
